(19) United States
(12) Patent Application Publication
(10) Pub. No.: US 2020/0142042 A1
(43) Pub. Date: May 7, 2020

(54) TARGET OBJECT DETECTION APPARATUS

(71) Applicants: Masato Hibino, Aichi (JP); Motomu Yokota, Aichi (JP)

(72) Inventors: Masato Hibino, Aichi (JP); Motomu Yokota, Aichi (JP)

(73) Assignee: OMRON AUTOMOTIVE ELECTRONICS CO., LTD., Aichi (JP)

(21) Appl. No.: 16/659,175

(22) Filed: Oct. 21, 2019

(30) Foreign Application Priority Data
Nov. 6, 2018 (JP) 2018-208555

(51) Int. Cl. G01S 7/497; G01S 17/02

(52) U.S. Cl. CPC G01S 7/497; G01S 2007/4975; G01S 17/026

(57) ABSTRACT

In a target object detection apparatus, an LD module projects laser light onto a predetermined range, and a PD module receives the reflected light from a target object, and outputs a light reception signal. Based on the light reception signal, an object detector detects presence or absence of the target object and a distance from the target object detection apparatus to the target object, and a dirt detector detects presence or absence of dirt on an optical window. The dirt detector detects, based on the light reception signal, dirt levels in units of segments in a detection field-of-view of the target object detection apparatus, and also detects a density and an extent of the dirt, based on the dirt levels. A controller causes an interface to notify a vehicle-side ECU of the result of detection as to the dirt.

### CROSS-REFERENCE TO RELATED APPLICATION

This application is based on Japanese Patent Application No. 2018-208555 filed with the Japan Patent Office on Nov. 6, 2018, the entire contents of which are incorporated herein by reference.

### FIELD

One or more embodiments of the disclosure relate to a target object detection apparatus for projecting and receiving light onto and from a target object to detect presence or absence of the target object and a distance from the target object detection apparatus to the target object. One or more embodiments of the disclosure particularly relate to a technique of detecting dirt on an optical window serving as a light outlet or light inlet of a target object detection apparatus.

### BACKGROUND

As disclosed in, for example, JP 2012-192775 A, JP 2005-010094 A, and JP 2018-072288 A, a target object detection apparatus such as an on-vehicle laser radar causes a light emitter to project measurement light onto a predetermined range. The target object detection apparatus then causes a light receiver to receive the reflected light from a target object in the predetermined range. The target object detection apparatus thus detects presence or absence of the target object and a distance from the target object detection apparatus to the target object, based on a light reception signal output from the light receiver. The light emitter includes a light emitting element such as a laser diode. The light receiver includes a light receiving element such as a photodiode.

In the target object detection apparatus, components of an optical system and components of an electrical system are housed in a casing that shields light. The casing has an optical window. The optical window is made of a light transmissive material, such as glass or resin, that allows transmission of light. The optical window serves as a light outlet through which light goes out of the casing or a light inlet through which light enters the casing. The target object detection apparatus is mounted to, for example, a vehicle such that the optical window is directed to a predetermined range where a target object is detected. Measurement light emitted from the light emitter thus transmits through the optical window, and then is projected onto the predetermined range. In addition, the reflected light from the target object in the predetermined range transmits through the optical window, and then is received by the light receiver.

If the optical window is dirty, the dirt hinders the measurement light from the light emitter from being projected out of the casing, and also hinders the reflected light from the external target object from entering the casing. Because of the dirt, the target object detection apparatus fails to detect the target object. In view of this, for example, JP 2012-192775 A, JP 2005-010094 A, and JP 2018-072288 A each propose a technique of detecting dirt on an optical window.

A target object detection apparatus disclosed in JP 2012-192775 A changes a direction of laser light emitted from a light emitting element to a vertically downward direction, and detects presence or absence of dirt on an optical window, based on whether a light receiving element detects reflected light from a road surface. Upon detection of the presence of the dirt on the optical window, the target object detection apparatus displays a warning about the presence of the dirt.

A target object detection apparatus disclosed in JP 2005-010094 A determines that an optical window (apparatus surface) is dirty on condition that, of a plurality of laser light beams emitted from light emitting elements, laser light beams, the number of which is equal to or more than a predetermined number, are high in strength to such an extent that a measurement time from the emission to reception of the corresponding reflected light is shorter than a predetermined time and a pulse of the corresponding reflected light exceeds an upper threshold value. Upon detection of the presence of the dirt on the optical window, the target object detection apparatus displays the presence of the dirt on an abnormality display.

A target object detection apparatus disclosed in JP 2018-072288 A measures distances from the target object detection apparatus to a target object for each of pixels in a detection field-of-view of the target object detection apparatus fronting on a predetermined range through an optical window. The distances thus measured are stored in a memory. The target object detection apparatus then calculates an area of a pixel group corresponding to a distance from the target object to a surface of the optical window, of the distances stored in the memory. In other words, the target object detection apparatus calculates an area of dirt on the optical window. The target object detection apparatus transmits to a steering system a notification signal for decelerating a vehicle or a notification signal for stopping a vehicle, in accordance with the area thus calculated.

Upon detection of presence of dirt on an optical window, a target object detection apparatus known in the related art has displayed the presence of the dirt to urge a user to remove the dirt from the optical window. However, even when a small amount of dirt adheres to a part of the optical window to such an extent that the dirt does not exert an adverse influence on detection performance of the target object detection apparatus or even when dirt to be removed naturally by, for example, wind or rain adheres to the optical window, the target object detection apparatus displays the presence of the dirt, which may make the user feel burdensome in some instances. If such minor dirt is manually removed in accordance with the display about the presence of the dirt on the optical window, a wasteful effort is required in some instances. In addition, if the dirt is removed with a cleaning fluid of a vehicle, the cleaning fluid is wasted in some instances. If the target object detection apparatus displays presence of dirt on the optical window each time dirt adheres to the optical window, the user is apt to leave the dirt since the user feels removal of the dirt burdensome. If the left dirt is, for example, dense dirt adhering to substantially the entire optical window, the dirt may continuously exert an adverse influence on the detection performance of the target object detection apparatus.

### SUMMARY

One or more embodiments of the disclosure provide a target object detection apparatus capable of closely detecting a state of dirt on an optical window, thereby taking appropriate measures against the dirt on the optical window.

According to one or more embodiments of the disclosure, a target object detection apparatus includes: a light emitter configured to emit measurement light; a light receiver configured to receive reflected light from a target object in a predetermined range onto which the light emitter projects the measurement light, the light receiver being configured to output a light reception signal according to a light reception state; an object detector configured to detect presence or absence of the target object or a distance from the target object detection apparatus to the target object, based on the light reception signal output from the light receiver; an optical window including a light transmissive material that allows transmission of light and serving as a light outlet for the measurement light or a light inlet for the reflected light; a dirt detector configured to detect presence or absence of dirt on the optical window, based on the light reception signal; and a notifier configured to provide a notification about the presence of the dirt on the optical window. The dirt detector detects, based on the light reception signal output from the light receiver, dirt levels in units of segments in a detection field-of-view of the target object detection apparatus fronting on the predetermined range through the optical window, and detects a density and an extent of the dirt, based on the dirt levels. The notifier provides a notification about a result of detection by the dirt detector as to the dirt.

According to one or more embodiments of the disclosure, the dirt detector detects, based on a light reception signal output from the light receiver, dirt levels in units of segments in the detection field-of-view of the target object detection apparatus fronting on the predetermined range, where the target object detection apparatus detects the target object, through the optical window. The dirt detector then detects a density and an extent of the dirt, based on the dirt levels. Therefore, the dirt detector closely detects a state of dirt, such as a position of dense dirt and a position of sparse dirt, in the entire detection field-of-view of the target object detection apparatus, that is, in the entire light transmission region of the optical window. The notifier provides a notification about the state of the dirt on the optical window thus closely detected. A user or an external apparatus therefore takes appropriate measures against the dirt. For example, the user or external apparatus removes the dirt from the optical window or leaves the dirt as it is.

According to one or more embodiments of the disclosure, in the target object detection apparatus, the light emitter may include a plurality of light emitting elements, and the light receiver may include a plurality of light receiving elements. The target object detection apparatus may further include a light scanner configured to scan the predetermined range with the measurement light emitted from each light emitting element or to guide the reflected light to the light receiver.

According to one or more embodiments of the disclosure, in the target object detection apparatus, the dirt detector may calculate a sum of the dirt levels and an average value of dirt levels in segments where the dirt extends, in each segment group that is a subset of segments adjoining one another, and may detect the density and extent of the dirt, based on the sum and the average value.

According to one or more embodiments of the disclosure, in the target object detection apparatus, the dirt detector may detect the density and extent of the dirt on the entire optical window, based on a result of detection in each segment group as to the dirt.

According to one or more embodiments of the disclosure, in the target object detection apparatus, the dirt detector may estimate a type of the dirt, based on a result of detection in each segment group as to the dirt, and the notifier may provide a notification about the type of the dirt estimated by the dirt detector.

According to one or more embodiments of the disclosure, in the target object detection apparatus, the dirt detector may determine urgency of dirt removal, based on a result of detection in each segment group as to the dirt, and the notifier may provide a notification about the urgency of dirt removal determined by the dirt detector.

One or more embodiments of the disclosure may provide a target object detection apparatus capable of closely detecting a state of dirt on an optical window, thereby taking appropriate measures against the dirt on the optical window.

### BRIEF DESCRIPTION OF THE DRAWINGS

FIG. 1 is an electrical block diagram of a target object detection apparatus according to one or more embodiments of the disclosure;

FIG. 2 illustrates an arrangement of LDs and PDs illustrated in FIG. 1;

FIG. 3 is a rear view of an optical system in the target object detection apparatus illustrated in FIG. 1;

FIG. 4A illustrates a light projection path of the optical system in the target object detection apparatus illustrated in FIG. 1;

FIG. 4B illustrates a light reception path of the optical system in the target object detection apparatus illustrated in FIG. 1;

FIG. 5 illustrates a detection field-of-view of the target object detection apparatus illustrated in FIG. 1;

FIG. 6 illustrates an exemplary light projection and reception state of the target object detection apparatus illustrated in FIG. 1 and an exemplary light reception signal;

FIG. 7 illustrates an exemplary light projection and reception state of the target object detection apparatus illustrated in FIG. 1 and an exemplary light reception signal;

FIG. 8 illustrates an exemplary light projection and reception state of the target object detection apparatus illustrated in FIG. 1 and an exemplary light reception signal;

FIG. 9 is a flowchart of operations of the target object detection apparatus illustrated in FIG. 1;

FIG. 10 illustrates criteria for a density and an extent of dirt to be determined by the target object detection apparatus illustrated in FIG. 1;

FIG. 11A illustrates an exemplary density and an exemplary extent of dirt in each segment group in the detection field-of-view of the target object detection apparatus illustrated in FIG. 1;

FIG. 11B illustrates an exemplary density and an exemplary extent of dirt in each segment group in the detection field-of-view of the target object detection apparatus illustrated in FIG. 1;

FIG. 11C illustrates an exemplary density and an exemplary extent of dirt in each segment group in the detection field-of-view of the target object detection apparatus illustrated in FIG. 1; and

FIG. 11D illustrates an exemplary density and an exemplary extent of dirt in each segment group in the detection field-of-view of the target object detection apparatus illustrated in FIG. 1.

### DETAILED DESCRIPTION

Embodiments of the disclosure will be described with reference to the drawings. In the drawings, the identical or equivalent component is designated by the identical numeral. In embodiments of the disclosure, numerous specific details are set forth in order to provide a more through understanding of the invention. However, it will be apparent to one of ordinary skill in the art that the invention may be practiced without these specific details. In other instances, well-known features have not been described in detail to avoid obscuring the invention.

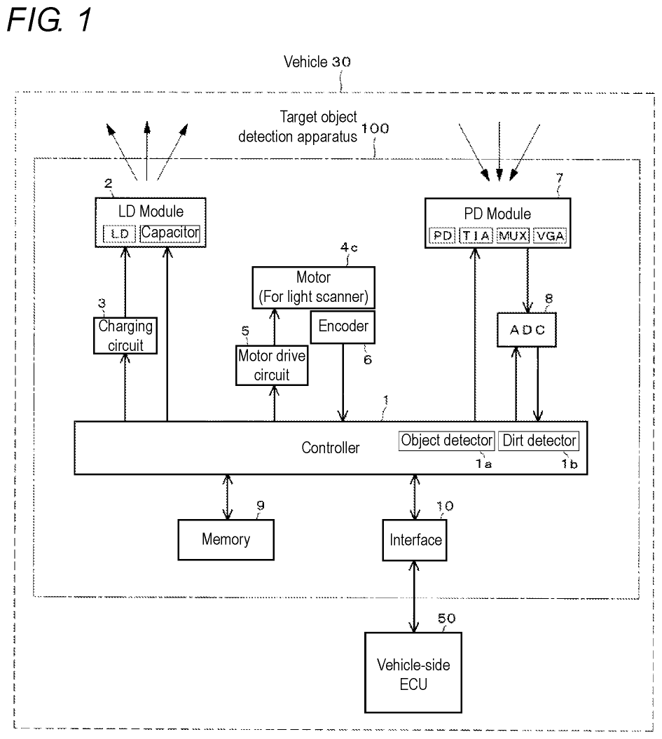

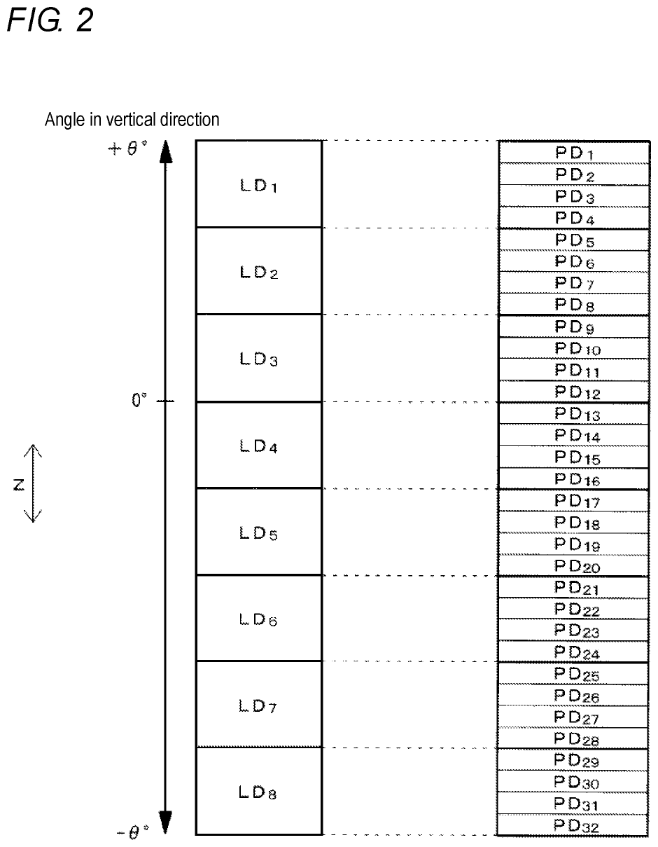

FIG. 1 is an electrical block diagram of a target object detection apparatus 100. FIG. 2 illustrates an arrangement of laser diodes (LDs) and photodiodes (PDs) in the target object detection apparatus 100.

The target object detection apparatus 100 is, for example, an optical laser radar to be installed in a vehicle 30 such as a four-wheel automobile. The target object detection apparatus 100 detects a target object such as another vehicle, a human, a road (e.g., a road surface), or any object.

The target object detection apparatus 100 includes a controller 1, an LD module 2, a charging circuit 3, a motor 4c, a motor drive circuit 5, an encoder 6, a PD module 7, an analog-to-digital converter (ADC) 8, a memory 9, and an interface 10.

The controller 1 is constituted of, for example, a central processing unit (CPU), and is configured to control operations of the respective components. The controller 1 includes an object detector 1a and a dirt detector 1b. The functions of the object detector 1a and dirt detector 1b are respectively implemented by software programs to be executed by the CPU of the controller 1.

The LD module 2 includes, for example, an LD that serves as a light source, and a capacitor that causes the LD to emit light. The LD is a light emitting element that emits a high-power optical pulse. FIG. 1 illustrates one LD and one capacitor in the form of a block for convenience. The LD module 2 actually includes a plurality of LDs (e.g., LD₁ to LD₈ illustrated in FIG. 2) and a plurality of capacitors (not illustrated in FIG. 2) for the respective LDs (i.e., LD₁ to LD₈). The LDs (i.e., LD₁ to LD₈) are arranged in a vertical direction Z. In the following, the LDs (i.e., LD₁ to LD₈) are collectively described as appropriate. The LD module 2 is an example of a “light emitter” according to one or more embodiments of the disclosure.

The charging circuit 3 illustrated in FIG. 1 electrically charges the capacitor in the LD module 2. FIG. 1 illustrates one charging circuit 3 in the form of a block. The target object detection apparatus 100 may include a plurality of charging circuits 3 in accordance with the number of LDs and the number of capacitors.

The controller 1 controls the light emitting operation of the LD and the charging operation of the charging circuit 3. Specifically, the controller 1 causes the LD to emit light, thereby projecting laser light (measurement light) onto a predetermined range. In addition, the controller 1 causes the LD to stop the light emission, and also causes the charging circuit 3 to electrically charge the capacitor.

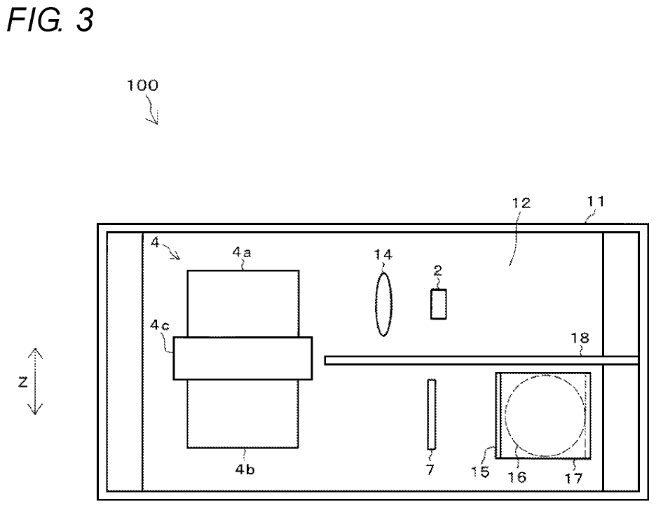

The motor 4c serves as a drive source for a light scanner 4 to be described later with reference to, for example, FIG. 3. The motor drive circuit 5 drives the motor 4c. The encoder 6 detects rotational states, such as an angle and a rotational speed, of the motor 4c. The controller 1 causes the motor drive circuit 5 to rotate the motor 4c, and controls an operation of the light scanner 4. In addition, the controller 1 detects operational states, such as an operation amount and an operating position, of the light scanner 4, based on an output from the encoder 6.

The PD module 7 includes, for example, a PD that serves as a light receiving element, a transimpedance amplifier (TIA), a multiplexer (MUX), and a variable gain amplifier (VGA). The details of each circuit are not illustrated in the drawings. FIG. 1 illustrates one PD and one TIA in the form of a block for convenience. The PD module 7 actually includes a plurality of PDs (e.g., PD₁ to PD₃₂ illustrated in FIG. 2) and a plurality of TIAs (not illustrated in FIG. 2) for the respective PDs (i.e., PD₁ to PD₃₂). The PDs (i.e., PD₁ to PD₃₂) are arranged in the vertical direction Z. In the example illustrated in FIG. 2, four PDs (i.e., PD₁ to PD₄, PD₅ to PD₈, PD₉ to PD₁₂, PD₁₃ to PD₁₆, PD₁₇ to PD₂₀, PD₂₁ to PD₂₄, PD₂₆ to PD₂₈, PD₂₉ to PD₃₂) are provided for each LD (i.e., LD₁, LD₂, LD₃, LD₄, LD₅, LD₆, LD₇, LD₈). In the following, the PDs (i.e., PD₁ to PD₃₂) are collectively described as appropriate. The PD module 7 is an example of a “light receiver” according to one or more embodiments of the disclosure.

The PD receives light, and outputs a current (light reception signal) according to the light reception state. The TIA converts into a voltage signal the current flowing through the PD, and outputs the voltage signal to the MUX. The MUX selects the output signal from the TIA, and outputs the selected signal to the VGA. The VGA amplifies the output signal from the MUX, and outputs the amplified signal to the ADC 8.

The ADC 8 receives the analog signal from the VGA, rapidly converts the analog signal into a digital signal, and outputs the digital signal to the controller 1. In the PD module 7, the light reception signal according to the light reception state of the PD is thus subjected to signal processing by each of the TIA, the MUX, and the VGA, and then is output to the controller 1 via the ADC 8. FIG. 1 illustrates one MUX, one VGA, and one ADC 8 in the form of a block. The target object detection apparatus 100 may include a plurality of MUXs, a plurality of VGAs, and a plurality of ADCs 8 in accordance with the number of PDs.

The controller 1 controls the operations of the respective components in the PD module 7. Specifically, for example, the controller 1 causes the LD in the LD module 2 to emit light, thereby projecting laser light onto the predetermined range, and then causes the PD in the PD module 7 to receive reflected light from a target object in the predetermined range. In these operations, the controller 1 causes the LDs (i.e., LD₁ to LD₈ in FIG. 2) to sequentially emit light, thereby projecting laser light, and causes the corresponding PDs (i.e., PD₁ to PD₃₂ in FIG. 2) to sequentially receive the reflected light. The controller 1 then subjects a light reception signal output from each of the PDs (i.e., PD₁ to PD₃₂) in accordance with the light reception state to signal processing by each of the TIA and the VGA. The controller 1 also causes the ADC 8 to convert the analog light reception signals from the PD module 7 into digital light reception signals.

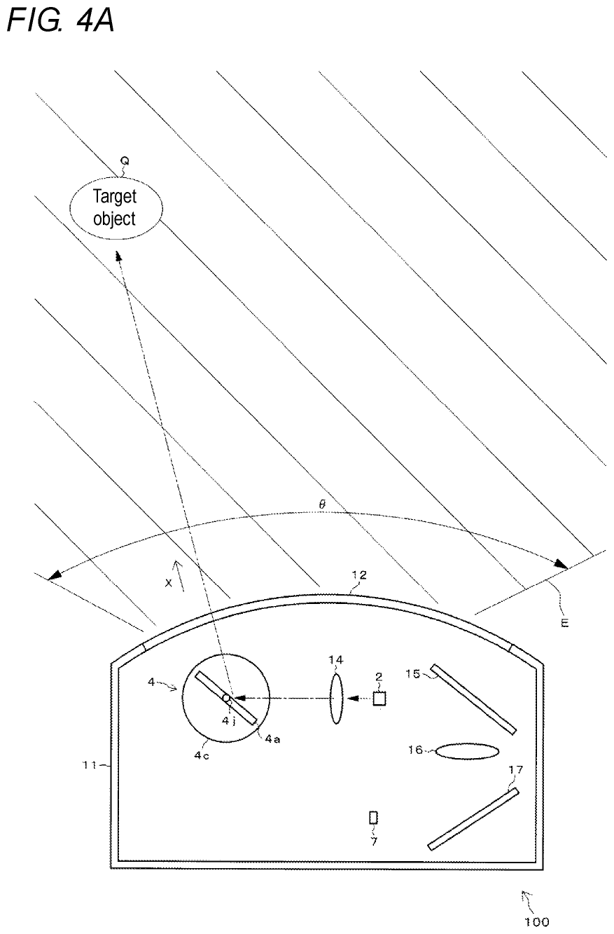

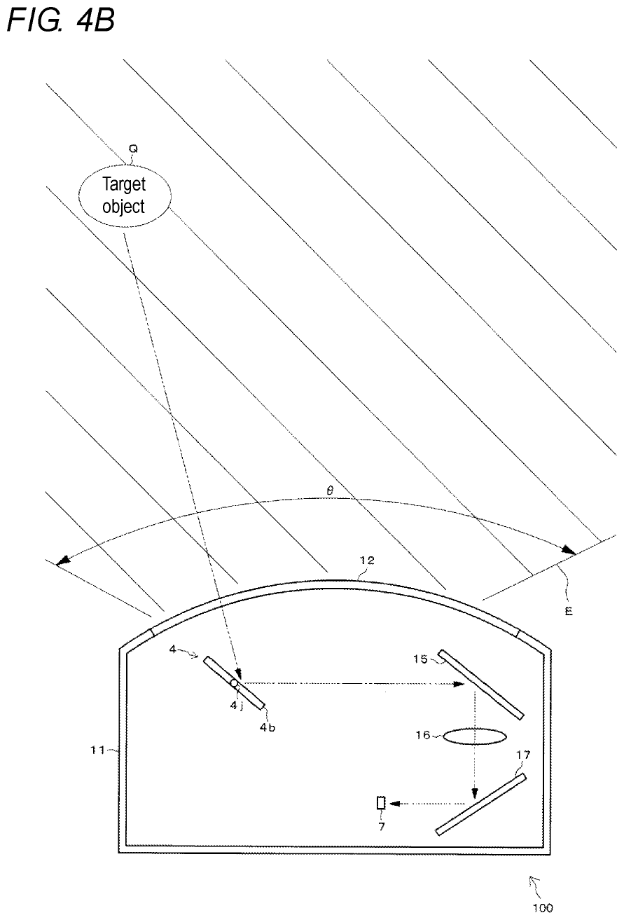

Based on the digital light reception signals thus converted by the ADC 8, the object detector 1a of the controller 1 detects presence or absence of the target object and a distance from the target object detection apparatus 100 to the target object, and the dirt detector 1b of the controller 1 detects presence or absence of dirt on an optical window 12 to be described later with reference to, for example, FIG. 4A.

The memory 9 is a volatile memory or a nonvolatile memory. The memory 9 stores therein, for example, information for the controller 1 in controlling the respective components of the target object detection apparatus 100, and information for the controller 1 in detecting a target object. The memory 9 also stores therein a result of detection by the dirt detector 1b of the controller 1 as to dirt on the optical window 12.

The interface 10 includes a communication circuit for establishing communications with a vehicle-side electronic control unit (ECU) 50. The controller 1 transmits and receives various kinds of control information to and from the vehicle-side ECU 50 via the interface 10. In addition, the controller 1 transmits a result of detection by the object detector 1a and a result of detection by the dirt detector 1b. Each of the controller 1 and the interface 10 is an example of a “notifier” according to one or more embodiments of the disclosure.

The vehicle-side ECU 50 receives a result of detection as to a target object from the target object detection apparatus 100, and controls an operation of, for example, an on-vehicle device (not illustrated) in a steering system installed in the vehicle 30, based on the result of detection. The vehicle-side ECU 50 thus causes the vehicle 30 to travel and stop. In addition, the vehicle-side ECU 50 receives a result of detection as to dirt on the optical window 12 from the target object detection apparatus 100, and transmits an operation command to the on-vehicle device, based on the result of detection.

Specifically, for example, the vehicle-side ECU 50 transmits a dirt warning command to a display (not illustrated) mounted to a cabin of the vehicle 30. The display thus displays thereon a warning that the optical window 12 is dirty, and a state of dirt on the optical window 12 to prompt a user to take appropriate measures, such as removal, against the dirt. Alternatively, for example, the vehicle-side ECU 50 transmits a dirt cleaning command to a cleaning apparatus (not illustrated) installed in the vehicle 30. The cleaning apparatus thus jets a cleaning fluid onto the optical window 12 to remove the dirt from the optical window 12.

FIG. 3 is a rear view of an optical system in the target object detection apparatus 100. FIG. 4A illustrates a light projection path of the optical system in the target object detection apparatus 100. FIG. 4B illustrates a light reception path of the optical system in the target object detection apparatus 100.

FIGS. 4A and 4B each illustrate the interior of the target object detection apparatus 100 seen from above. FIG. 3 illustrates the interior of the target object detection apparatus 100 seen from the rear (from below in FIG. 4A).

A casing 11 is formed in a box shape, and is made of synthetic resin that blocks transmission of light. As illustrated in FIGS. 4A and 4B, the casing 11 has in its front side the optical window 12. The optical window 12 is made of a light transmissive material, such as synthetic resin or glass, that permits transmission of light. The optical window 12 serves as a light inlet through which light enters the casing 11 and a light outlet through which light goes out of the casing 11.

The target object detection apparatus 100 is mounted on the front, rear, left, or right side of the vehicle 30 such that the optical window 12 is directed forward, rearward, leftward, or rightward of the vehicle 30, and the shorter edge of the casing 11 and the vertical direction (heightwise direction) Z become parallel.

As illustrated in FIGS. 3, 4A, and 4B, the casing 11 accommodates therein optical system components such as the LD module 2, a light projecting lens 14, the light scanner 4, a reflecting mirror 15, a light receiving lens 16, a reflecting mirror 17, and the PD module 7. Of the optical system components, the LD module 2, the motor 4c of the light scanner 4, and the PD module 7 are electronic components to be electrically driven. The casing 11 also accommodates therein other electronic components illustrated in FIG. 1. It should be noted that FIG. 4B does not illustrate the LD module 2, the light projecting lens 14, a light projecting mirror 4a (to be described later) of the light scanner 4, and the motor 4c of the light scanner 4.

The LD of the LD module 2, the light projecting lens 14, and the light scanner 4 constitute a light-projecting optical system. The light scanner 4, the reflecting mirror 15, the reflecting mirror 17, the light receiving lens 16, and the PD of the PD module 7 constitute a light-receiving optical system. As illustrated in FIG. 3, a light shielding plate 18 is disposed between the light-projecting optical system and the light-receiving optical system in order to prevent interference of light. The light shielding plate 18 is not illustrated in FIGS. 4A and 4B. The LD module 2, the light projecting lens 14, the motor 4c of the light scanner 4, the reflecting mirror 15, the light receiving lens 16, the reflecting mirror 17, the PD module 7, and the light shielding plate 18 are fixedly disposed in the casing 11.

As illustrated in FIG. 3, the LD module 2 is disposed on an upper side of the target object detection apparatus 100 at a center of the target object detection apparatus 100. The light projecting lens 14 is disposed on the light emission side of the LD in the LD module 2. In FIGS. 3, 4A, and 4B, the light projecting lens 14 is disposed on the left side of the LD module 2. The light scanner 4 is disposed opposite the LD module 2 with respect to the light projecting lens 14.

The light scanner 4, which is also referred to as a light deflector, includes, for example, the light projecting mirror 4a, a light receiving mirror 4b, and the motor 4c. The motor 4c is a brushless motor. As illustrated in FIGS. 4A and 4B, the motor 4c has a pivot 4j. The light projecting mirror 4a is coupled to an upper end of the pivot 4j. In addition, the light receiving mirror 4b is coupled to a lower end of the pivot 4j. Each of the light projecting mirror 4a and the light receiving mirror 4b is a double-sided mirror formed in a plate shape. In other words, each of the light projecting mirror 4a and the light receiving mirror 4b has two plate planes each formed as a reflection plane. The light projecting mirror 4a and the light receiving mirror 4b rotate in conjunction with the pivot 4j of the motor 4c. The pivot 4j of the motor 4c is disposed in parallel with the vertical direction Z.

The PD module 7 is disposed on a lower side of the target object detection apparatus 100 at the center of the target object detection apparatus 100. The reflecting mirror 15, the light receiving lens 16, and the reflecting mirror 17 are disposed opposite the light scanner 4 with respect to the PD module 7. The PD module 7, the reflecting mirror 15, the light receiving lens 16, and the reflecting mirror 17 are disposed below the LD module 2.

The reflecting mirror 17 is disposed on the light reception side of the PD in the PD module 7. In FIGS. 3, 4A, and 4B, the reflecting mirror 17 is disposed on the right side of the PD module 7. In addition, the reflecting mirror 17 is inclined at a predetermined angle. The reflecting mirror 15 is disposed forward of the reflecting mirror 17. In other words, the reflecting mirror 15 is disposed closer to the optical window 12 than the reflecting mirror 17 is. In addition, the reflecting mirror 15 is inclined at a predetermined angle. The light receiving lens 16 is disposed between the reflecting mirror 17 and the reflecting mirror 15.

In FIG. 4A, an alternate long and short dash arrow indicates the light projection path of the light-projecting optical system. First, the LD in the LD module 2 emits light. The light is adjusted as to its expansion by the light projecting lens 14, and then reaches the light projecting mirror 4a of the light scanner 4. At this time, the motor 4c rotates to change an angle (orientation) of the light projecting mirror 4a, so that one of the reflection planes of the light projecting mirror 4a is directed toward the predetermined range E. The light from the LD transmits through the light projecting lens 14, and then is reflected at the light projecting mirror 4a. The light from the LD thus transmits through almost the upper half of the optical window 12, and then is projected onto the external predetermined range E.

In FIGS. 4A and 4B, a hatched portion indicates the predetermined range E corresponding to a range near the target object detection apparatus 100 in a range to be scanned by the target object detection apparatus 100 with light projected onto and received from the range. Since the pivot 4j of the light projecting mirror 4a and light receiving mirror 4b is disposed in parallel with the vertical direction Z, the light scanner 4 scans the predetermined range E with laser light and the reflected light in a predetermined angular range θ within a horizontal plane. In addition, since the plurality of LDs and the plurality of PDs are arranged in the vertical direction Z, the laser light and the reflected light are projected and received in a predetermined angular range within a vertical plane.

As illustrated in FIG. 4A, when a target object Q is in the predetermined range E, light projected from the target object detection apparatus 100 onto the predetermined range E is reflected from the target object Q. In FIG. 4B, an alternate long and two short dashes arrow indicates the light reception path of the light-receiving optical system in the target object detection apparatus 100 in receiving the reflected light from the target object Q.

As illustrated in FIG. 4B, the light from the target object detection apparatus 100 is reflected from the target object Q. The reflected light from the target object Q transmits through the optical window 12, and then reaches the light receiving mirror 4b of the light scanner 4. At this time, the motor 4c rotates to change an angle (orientation) of the reflection planes of the light receiving mirror 4b, so that one of the reflection planes of the light receiving mirror 4b is directed toward the predetermined range E. The reflected light from the target object Q thus transmits through almost the lower half of the optical window 12, is reflected by the light receiving mirror 4b, and is guided to the reflecting mirror 15. In other words, the light scanner 4 deflects toward the reflecting mirror 15 the reflected light from the target object Q in the predetermined range E. The reflected light, which is guided to the reflecting mirror 15 by the light scanner 4, is reflected at the reflecting mirror 15 to enter the light receiving lens 16. The reflected light is condensed and adjusted by the light receiving lens 16, and then is reflected at the reflecting mirror 17. Thereafter, the reflected light is received by the PD in the PD module 7.

The PD outputs a light reception signal in accordance with the reflected light reception state. The light reception signal is subjected to signal processing by each of the PD module 7 and the ADC 8. Based on the light reception signal thus subjected to signal processing, the object detector 1a of the controller 1 detects presence or absence of the target object Q and a distance from the target object detection apparatus 100 to the target object Q.

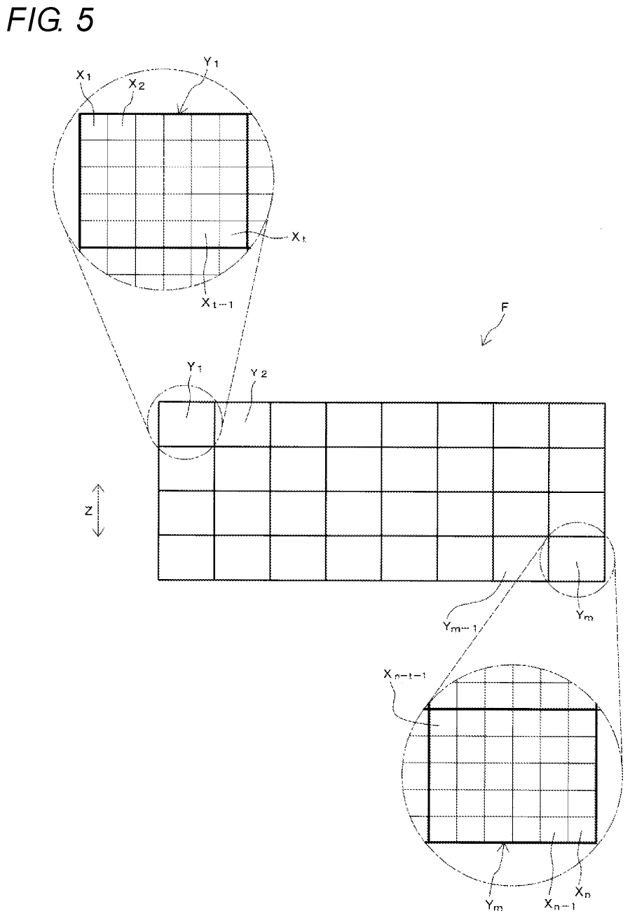

FIG. 5 illustrates a detection field-of-view F of the target object detection apparatus 100.

The detection field-of-view F illustrated in FIG. 5 is a field of view of the target object detection apparatus 100 in the predetermined range E where the target object detection apparatus 100 detects the target object Q. The detection field-of-view F corresponds to a light transmission region of the optical window 12 where laser light and the reflected light are transmittable. The detection field-of-view F is divided into segments X₁ to Xₙ arranged in a grid form. The target object detection apparatus 100 projects laser light in units of segments X₁ to Xₙ, and receives the reflected light in units of segments X₁ to Xₙ. The PD module 7 outputs light reception signals in units of segments X₁ to Xₙ. Based on the light reception signals, the controller 1 detects presence or absence of the target object Q and a distance from the target object detection apparatus 100 to the target object Q. The controller 1 also detects presence or absence of dirt on the optical window 12. In addition, the controller 1 makes a determination as to a state of dirt on the optical window 12 in units of segment groups Y₁ to Yₘ each of which is a subset of segments adjoining one another. In the example illustrated in FIG. 5, each of the segment groups Y₁ to Yₘ consists of t (t<n) segments arranged in a matrix.

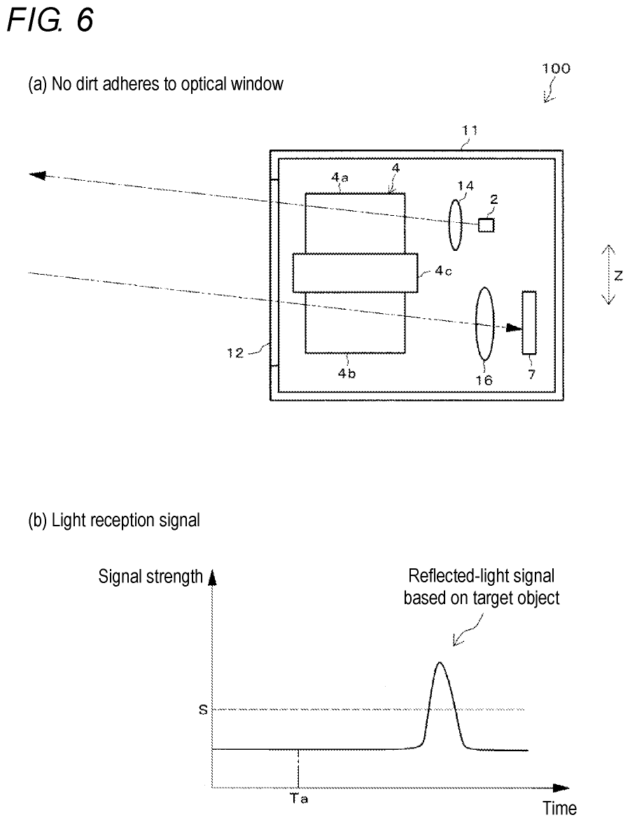

FIGS. 6, 7, and 8 each illustrate an exemplary light projection and reception state of the target object detection apparatus 100 and an exemplary light reception signal.

In FIGS. 6 to 8, upper schematic diagrams (a) each illustrate the optical system in the target object detection apparatus 100 seen sideways; however, the reflecting mirror 15, the reflecting mirror 17, and the light shielding plate 18 are not illustrated in FIGS. 6 to 8. Also in FIGS. 6 to 8, lower graphs (b) each illustrate a change in light reception signal output from the PD module 7. In each of the graphs, the horizontal axis represents a time, and the vertical axis represents a signal strength.

As illustrated in (a) of FIG. 6, when the optical window 12 is not dirty, laser light emitted from the LD in the LD module 2 passes through the light projecting lens 14 and the light projecting mirror 4a of the light scanner 4, and then transmits through the optical window 12. The laser light is thus projected onto the predetermined range E illustrated in FIG. 4A. Next, the reflected light from the target object Q in the predetermined range E transmits through the optical window 12, and then passes through, for example, the light receiving mirror 4b of the light scanner 4 and the light receiving lens 16. The reflected light is thus received by the PD in the PD module 7. In this case, as illustrated in (b) of FIG. 6, light reception signals to be output from the PD module 7 include a pulsewise reflected-light signal based on the target object Q.

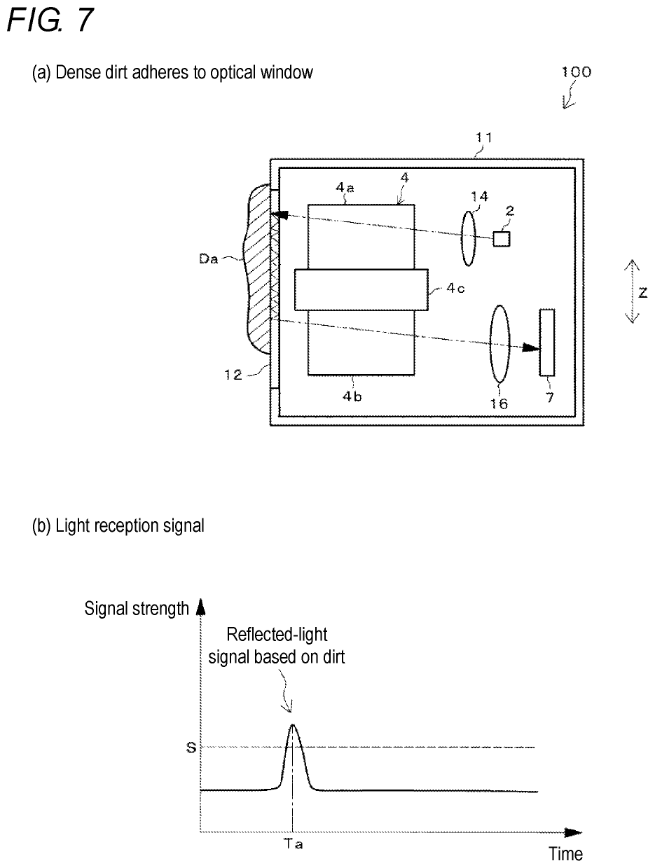

As illustrated in (a) of FIG. 7, when dense dirt Da adheres to the optical window 12, laser light from the LD in the LD module 2 passes through the light projecting lens 14 and the light projecting mirror 4a of the light scanner 4, and then transmits through the optical window 12; however, the laser light fails to transmit through the dense dirt Da. Consequently, the laser light is not projected onto the predetermined range E illustrated in FIG. 4A. Since the laser light is irregularly reflected at the optical window 12 and the dense dirt Da, the reflected light passes through, for example, the light receiving mirror 4b of the light scanner 4 and the light receiving lens 16, and then is received by the PD in the PD module 7. In this case, as illustrated in (b) of FIG. 7, light reception signals to be output from the PD module 7 include a pulsewise reflected-light signal based on the dense dirt Da.

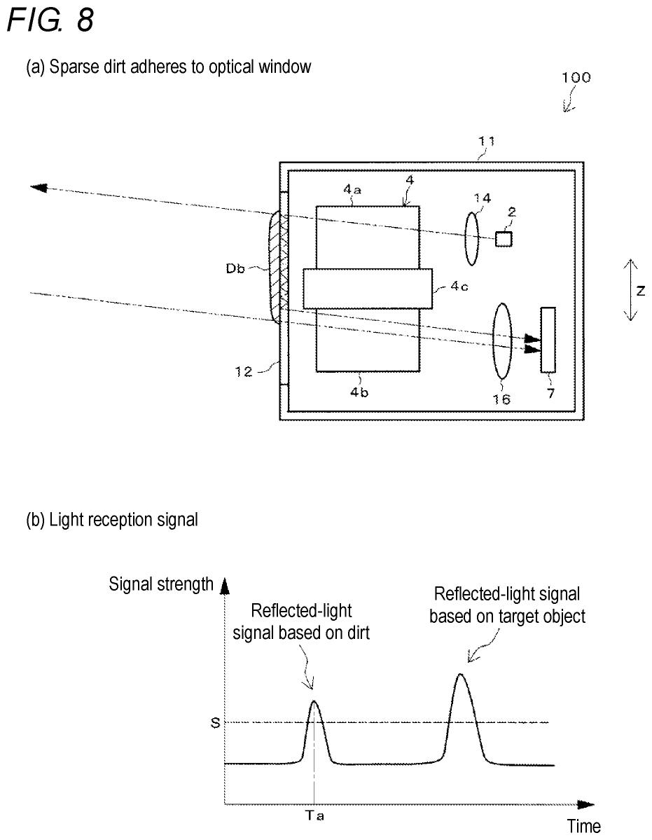

As illustrated in (a) of FIG. 8, when sparse dirt Db adheres to the optical window 12, laser light from the LD in the LD module 2 passes through the light projecting lens 14 and the light projecting mirror 4a of the light scanner 4, and then part of the laser light is irregularly reflected at the optical window 12 and the sparse dirt Db. The reflected light passes through, for example, the light receiving mirror 4b of the light scanner 4 and the light receiving lens 16, and is received by the PD in the PD module 7. Another part of the laser light transmits through the optical window 12, and is projected onto the predetermined range E illustrated in FIG. 4A. When the part of the laser light reaches the target object Q, the reflected light from the target object Q transmits through the optical window 12, and then passes through, for example, the light receiving mirror 4b of the light scanner 4 and the light receiving lens 16. The reflected light is then received by the PD in the PD module 7. In this case, as illustrated in (b) of FIG. 8, light reception signals to be output from the PD module 7 include a pulsewise reflected-light signal based on the sparse dirt Db and a pulsewise reflected-light signal based on the target object Q.

Even when sparse dirt Db and dense dirt Da adhere to a part of the optical window 12, laser light and the reflected light are projected and received in a manner similar to that described above, and light reception signals include a reflected-light signal based on the dense dirt Da, a reflected-light signal based on the sparse dirt Db, and a reflected-light signal based on the target object Q.

The controller 1 detects peaks of pulses in light reception signals output from the PD module 7 in units of segments X₁ to Xₙ illustrated in FIG. 5. At this time, the controller 1 detects a peak strength and a peak time as to each pulse, and stores the detected strength and time in the memory 9 as necessary. The controller 1 detects as a reflected-light signal a pulse having a peak strength that is equal to or more than a predetermined threshold value S (see (b) of FIG. 6, (b) of FIG. 7, (b) of FIG. 8). The controller 1 also detects as a reflected-light reception time a time at which the reflected-light signal reaches its peak value.

The object detector 1a calculates a period of time from a time, at which laser light as a source of the reflected-light signal detected by the controller 1 is projected, to the reflected-light reception time (i.e., a time of flight (TOF) of light), and also calculates a distance based on the time of flight, by the TOF method. When the distance is longer than a predetermined distance corresponding to a surface of the optical window 12, the object detector 1a determines that the target object Q is in the predetermined range E. The object detector 1a defines the distance as a distance from the target object detection apparatus 100 to the target object Q, and records the distance in the memory 9 with the distance correlated with the segments X₁ to Xₙ.

When the distance detected by the object detector 1a is equal to or less than the predetermined distance, the dirt detector 1b determines that the optical window 12 is dirty. The dirt detector 1b reads from the memory 9 a peak strength of the reflected-light signal in calculating the distance, detects a dirt level based on the peak strength, and records the dirt level in the memory 9 with the dirt level correlated with the segments X₁ to Xₙ. At this time, since the peak strength corresponds to an amount of received reflected light, the dirt detector 1b may calculate the dirt level, based on the peak strength and a predetermined operational expression. Alternatively, the dirt detector 1b may define the peak strength as the dirt level.

Light reception signals, from which pulses whose peak strengths are equal to or more than the predetermined threshold value S are not detected, include none of the reflected-light signal based on the target object Q, the reflected-light signal based on the dense dirt Da, and the reflected-light signal based on the sparse dirt Db. Therefore, the object detector 1a determines that no target object is in the predetermined range E, and the dirt detector 1b determines that the optical window 12 is not dirty. In this case, the object detector 1a does not detect the distance. In other words, the object detector 1a does not detect the distance from the target object detection apparatus 100 to the target object Q. However, the dirt detector 1b detects a dirt level, based on a signal strength of the light reception signal at a predetermined time Ta (see (b) of FIG. 6, (b) of FIG. 7, (b) of FIG. 8), and records the dirt level in the memory 9 with the dirt level correlated with the segments X₁ to Xₙ. The predetermined time Ta is set at, for example, a time from emission of laser light from the LD to reception, by the PD, of the reflected light from the surface of the optical window 12.

If one or more pulses whose peak strengths are equal to or more than the predetermined threshold value S are detected from the light reception signals, but all the distances calculated by the object detector 1a based on peak times of the respective pulses are longer than the predetermined distance, the light reception signals include only a reflected-light signal based on the target object Q as illustrated in (b) of FIG. 6. In this case, the object detector 1a determines that the target object Q is in the predetermined range E, and the dirt detector 1b determines that the optical window 12 is not dirty. The dirt detector 1b detects a dirt level, based on the signal strength of the light reception signal at the predetermined time Ta, and records the detected dirt level in the memory 9 with the dirt level correlated with the segments X₁ to Xₙ.

If one or more pulses whose peak strengths are equal to or more than the predetermined threshold value S are detected from the light reception signals, but all the distances calculated by the object detector 1a based on peak times of the respective pulses are equal to or less than the predetermined distance, the light reception signals include only a reflected-light signal based on dirt as illustrated in (b) of FIG. 7. In this case, the dirt detector 1b determines that the optical window 12 is dirty, and the object detector 1a determines that no target object is in the predetermined range E. Therefore, the distance calculated by the object detector 1a is not recorded as a distance from the target object detection apparatus 100 to the target object Q.

If the light reception signals include a reflected-light signal based on the target object Q and a reflected-light signal based on dirt as illustrated in (b) of FIG. 8, the object detector 1a determines that the target object Q is in the predetermined range E, and records the distance from the target object detection apparatus 100 to the target object Q in the memory 9. In addition, the dirt detector 1b determines that the optical window 12 is dirty, and records the dirt level in the memory 9.

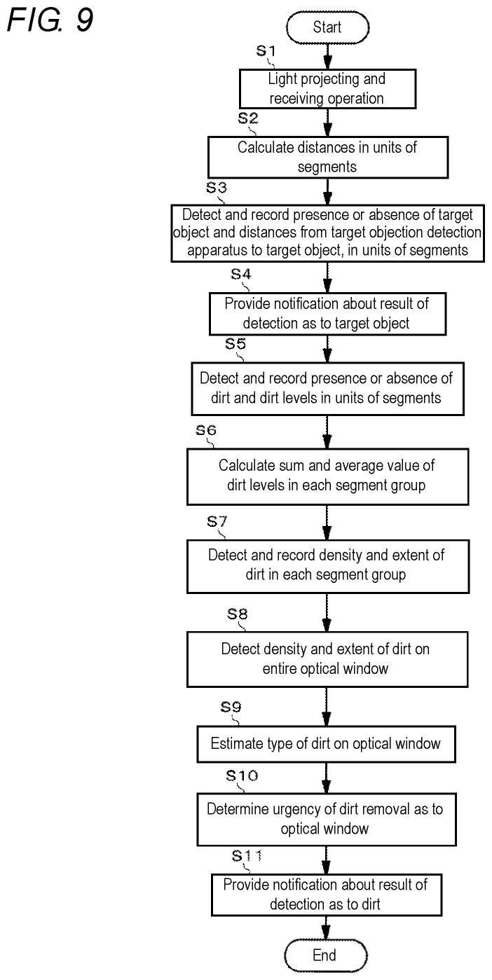

FIG. 9 is a flowchart of the operations of the target object detection apparatus 100.

In step S1 illustrated in FIG. 9, first, the controller 1 controls, for example, the LD module 2, the PD module 7, and the light scanner 4 to perform the operation of projecting and receiving light onto and from the predetermined range E. Specifically, the controller 1 rotates the light projecting mirror 4a and light receiving mirror 4b of the light scanner 4, and causes the LDs in the LD module 2 to sequentially emit light. The controller 1 then causes the light projecting mirror 4a to reflect laser light from each LD, thereby projecting the laser light onto the predetermined range E. The controller 1 then causes the light receiving mirror 4b to reflect the reflected light from the target object Q, the dense dirt Da, or the sparse dirt Db, and also causes the PDs in the PD module 7 to sequentially receive the reflected light. The controller 1 then subjects a light reception signal output from each PD to signal processing by each of the TIA, the MUX, the VGA, and the ADC 8.

In step S2 illustrated in FIG. 9, next, the controller 1 detects a reflected-light signal, based on light reception signals output from the PD module 7 in units of segments X₁ to Xₙ in the detection field-of-view F (see FIG. 5), and the object detector 1a calculates distances in units of segments X₁ to Xₙ. In step S3 illustrated in FIG. 9, based on all the distances thus calculated in units of segments X₁ to Xₙ, the object detector 1a detects presence or absence of the target object Q and distances from the target object detection apparatus 100 to the target object Q in units of segments X₁ to Xₙ, and records the results of detection in the memory 9. In step S4 illustrated in FIG. 9, the controller 1 causes the interface 10 to notify the vehicle-side ECU 50 of the results of detection as to the target object Q.

In step S5 illustrated in FIG. 9, based on the reflected-light signal detected by the controller 1 and the distances calculated by the object detector 1a, the dirt detector 1b detects presence or absence of dirt and dirt levels in units of segments X₁ to Xₙ, and records the results of detection in the memory 9. In step S6 illustrated in FIG. 9, next, the dirt detector 1b calculates a sum and an average value of the dirt levels in each of the segment groups Y₁ to Yₘ illustrated in FIG. 5. Specifically, the dirt detector 1b calculates a sum, that is, a total value of the dirt levels in all the segments in each of the segment groups Y₁ to Yₘ, and calculates an average value of dirt levels in segments where the dirt extends.

In step S7 illustrated in FIG. 9, next, the dirt detector 1b detects a density and an extent of the dirt in each of the segment groups Y₁ to Yₘ, based on the sum of the dirt levels, the average value of the dirt levels, and a predetermined criterion, and records the results of detection in the memory 9.

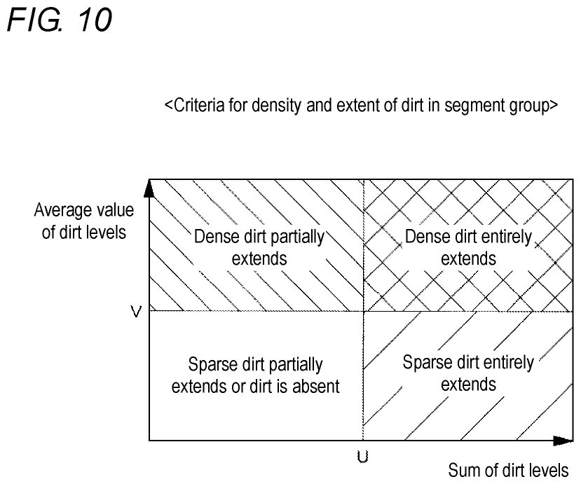

FIG. 10 illustrates criteria for a density and an extent of dirt to be determined by the target object detection apparatus 100. The memory 9 previously stores therein information on the criteria illustrated in FIG. 10.

In step S7 illustrated in FIG. 9, when the sum of the dirt levels in each of the segment groups Y₁ to Yₘ is smaller than a predetermined value U and the average value of the dirt levels in each of the segment groups Y₁ to Yₘ is smaller than a predetermined value V as illustrated in FIG. 10, the dirt detector 1b determines that sparse dirt Db is present in some of the segment groups Y₁ to Yₘ or determines that dense dirt Da and sparse dirt Db are absent in the segment groups Y₁ to Yₘ. When the sum of the dirt levels in each of the segment groups Y₁ to Yₘ is smaller than the predetermined value U and the average value of the dirt levels in each of the segment groups Y₁ to Yₘ is equal to or more than the predetermined value V, the dirt detector 1b determines that dense dirt Da is present in some of the segment groups Y₁ to Yₘ. When the sum of the dirt levels in each of the segment groups Y₁ to Yₘ is equal to or more than the predetermined value U and the average value of the dirt levels in each of the segment groups Y₁ to Yₘ is smaller than the predetermined value V, the dirt detector 1b determines that sparse dirt Db is present in all the segment groups Y₁ to Yₘ. When the sum of the dirt levels in each of the segment groups Y₁ to Yₘ is equal to or more than the predetermined value U and the average value of the dirt levels in each of the segment groups Y₁ to Yₘ is equal to or more than the predetermined value V, the dirt detector 1b determines that dense dirt Da is present in all the segment groups Y₁ to Yₘ.

In step S8 illustrated in FIG. 9, next, the dirt detector 1b detects a density and an extent of the dirt on the entire optical window 12, based on the results of detection as to the dirt in each of the segment groups Y₁ to Yₘ. In step S9 illustrated in FIG. 9, next, the dirt detector 1b estimates a type of the dirt on the optical window 12, based on the results of detection.

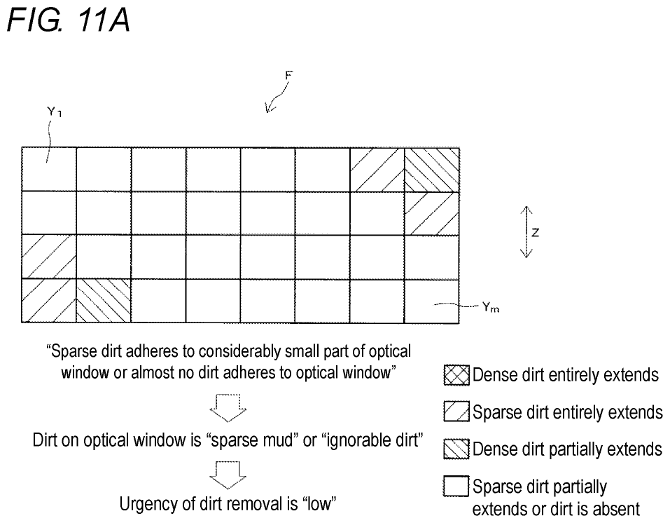

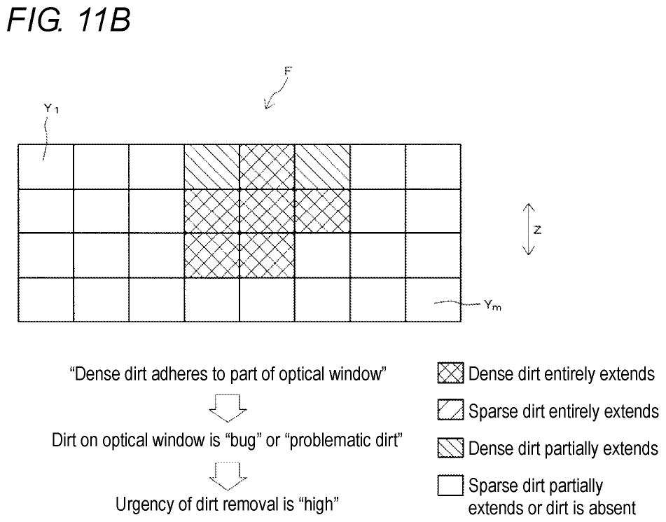

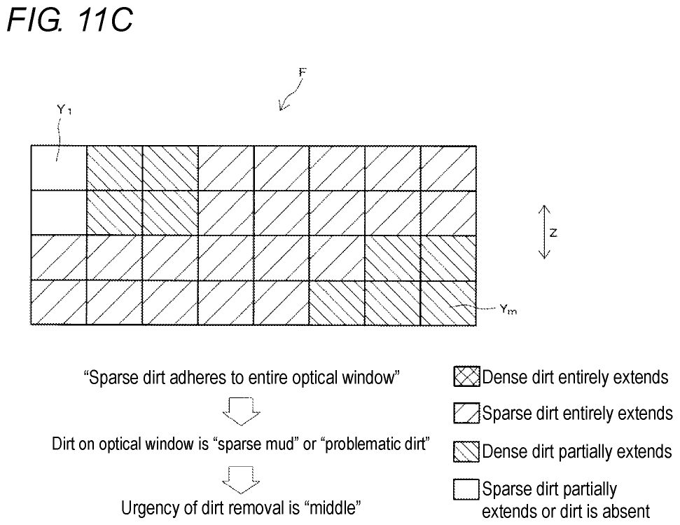

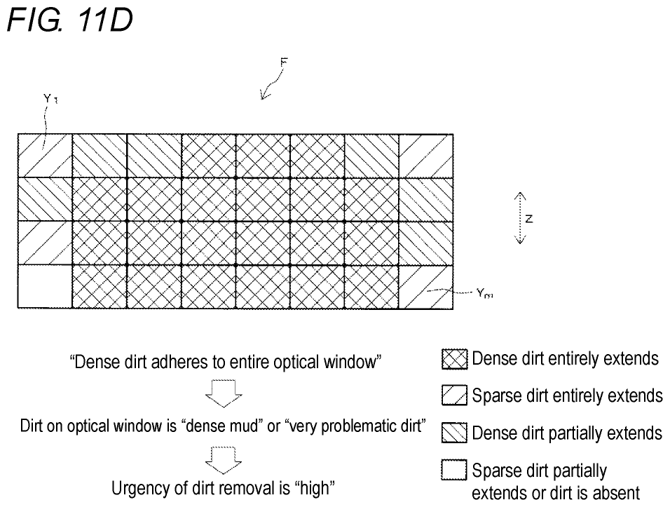

FIGS. 11A to 11D each illustrate an exemplary density and an exemplary extent of dirt in each of the segment groups Y₁ to Yₘ in the detection field-of-view F of the target object detection apparatus 100.

In FIGS. 11A to 11D, a segment group where dense dirt Da entirely extends is cross-hatched. A segment group where sparse dirt Db entirely extends is hatched with lines slanted upward to the right with wide pitches. A segment group where dense dirt Da partially extends is hatched with lines slanted upward to the left with narrow pitches. A segment group where sparse dirt Db partially extends or where dense dirt Da and sparse dirt Db are absent is not hatched. The same things may hold true for FIG. 10.

As illustrated in FIG. 11A, when most (e.g., at least 80 to 90%) of the segment groups in the detection field-of-view F are segment groups that are not hatched, that is, segment groups where sparse dirt partially extends or dirt is absent, and the segment groups in the detection field-of-view F include no segment groups that are cross-hatched, that is, no segment groups where dense dirt entirely extends, the dirt detector 1b determines in step S8 illustrated in FIG. 9 that sparse dirt Db adheres to a considerably small part of the optical window 12 or almost no dirt adheres to the optical window 12, and then estimates in step S9 illustrated in FIG. 9 that the dirt on the optical window 12 is “sparse mud” or “ignorable dirt”.

As illustrated in FIG. 11B, when some of the segment groups in the detection field-of-view F are segment groups that are cross-hatched, that is, segment groups where dense dirt entirely extends, the dirt detector 1b determines in step S8 illustrated in FIG. 9 that dense dirt Da adheres to a part of the optical window 12, and estimates in step S9 illustrated in FIG. 9 that the dirt on the optical window 12 is “bug”. As illustrated in FIG. 11B, when the segment groups in the detection field-of-view F include segment groups that are cross-hatched, that is, segment groups where dense dirt entirely extends, at a center of the detection field-of-view F, the dirt detector 1b estimates in step S9 illustrated in FIG. 9 that the dirt on the optical window 12 is “problematic dirt”.

As illustrated in FIG. 11C, when at least 50% of all the segment groups Y₁ to Yₘ in the detection field-of-view F are segment groups that are hatched with lines slanted upward to the right, that is, segment groups where sparse dirt entirely extends, the dirt detector 1b determines in step S8 illustrated in FIG. 9 that sparse dirt Db adheres to the entire optical window 12, and estimates in step S9 illustrated in FIG. 9 that the dirt on the optical window 12 is “sparse mud” or “problematic dirt”.

As illustrated in FIG. 11D, when at least 50% of all the segment groups Y₁ to Yₘ in the detection field-of-view F are segment groups that are cross-hatched, that is, segment groups where dense dirt entirely extends, the dirt detector 1b determines in step S8 illustrated in FIG. 9 that dense dirt Da adheres to the entire optical window 12, and estimates in step S9 illustrated in FIG. 9 that the dirt on the optical window 12 is “dense mud” and “very problematic dirt”.

The memory 9 previously stores therein information (criteria) for estimating a type of dirt as described above. With regard to a dirt pattern except for those illustrated in FIGS. 11A to 11D, the dirt detector 1b determines a density and an extent of dirt on the entire optical window 12, and estimates a type of the dirt.

In step S10 illustrated in FIG. 9, next, the dirt detector 1b determines urgency of dirt removal as to the optical window 12, based on the results of detection as to the dirt in each of the segment groups Y₁ to Yₘ.

As illustrated in FIG. 11A, when the dirt on the optical window 12 is “sparse mud” or “ignorable dirt”, the dirt detector 1b determines in step S10 illustrated in FIG. 9 that the urgency of dirt removal is “low”.

As illustrated in FIG. 11B, when the dirt on the optical window 12 is “bug” or “problematic dirt”, the dirt detector 1b determines in step S10 illustrated in FIG. 9 that the urgency of dirt removal is “high”. Although not illustrated in the drawings, when the segment groups in the detection field-of-view F include segment groups that are cross-hatched, that is, segment groups where dense dirt entirely extends, at an end of the detection field-of-view F, the dirt detector 1b determines in step S10 illustrated in FIG. 9 that the urgency of dirt removal is “low”.

As illustrated in FIG. 11C, when the dirt on the optical window 12 is “sparse mud” or “problematic dirt”, the dirt detector 1b determines in step S10 illustrated in FIG. 9 that the urgency of dirt removal is “middle”. As illustrated in FIG. 11D, when the dirt on the optical window 12 is “dense mud” or “very problematic dirt”, the dirt detector 1b determines in step S10 illustrated in FIG. 9 that the urgency of dirt removal is “high”.

Upon completion of the processing for dirt (steps S5 to S10 in FIG. 9) performed by the dirt detector 1b, in step S11 illustrated in FIG. 9, the controller 1 causes the interface 10 to notify the vehicle-side ECU 50 of the results of detection by the dirt detector 1b as to dirt. Specifically, the interface 10 notifies the vehicle-side ECU 50 of the density and extent of the dirt in each of the segment groups Y₁ to Yₘ, the density and extent of the dirt on the entire optical window 12, the type of the dirt, and the urgency of dirt removal, which are detected by the dirt detector 1b in steps S7 to S10 illustrated in FIG. 9.

Upon reception of a notification that the urgency of dirt removal is “high”, from the target object detection apparatus 100, for example, the vehicle-side ECU 50 causes the display in the vehicle 30 to display thereon a warning that the optical window 12 is dirty, with a high frequency or causes the cleaning apparatus in the vehicle 30 to automatically remove the dirt from the optical window 12. Upon reception of a notification that the urgency of dirt removal is “middle”, for example, the vehicle-side ECU 50 causes the display to display thereon a warning that the optical window 12 is dirty, with a low frequency.

Upon reception of a notification that the urgency of dirt removal is “low”, for example, the vehicle-side ECU 50 does not perform display of a warning that the optical window 12 is dirty and automatic dirt removal.

Based on the notification from the target object detection apparatus 100, that is, based on the density and extent of the dirt in each of the segment groups Y₁ to Yₘ or on the entire optical window 12, or the type of the dirt, the vehicle-side ECU 50 takes appropriate measures. For example, the vehicle-side ECU 50 changes the details of the warning displayed on the display. Alternatively, the vehicle-side ECU 50 changes a dirt removing method by the cleaning apparatus, such as an amount of cleaning fluid to be jetted from the cleaning apparatus.

According to one or more embodiments of the disclosure, the dirt detector 1b detects, based on light reception signals output from the PD module 7, dirt levels in units of segments X₁ to Xₙ in the detection field-of-view F of the target object detection apparatus 100 fronting on the predetermined range E, where the target object detection apparatus 100 detects the target object Q, through the optical window 12. The dirt detector 1b then detects a density and an extent of dirt, based on the dirt levels. Therefore, the dirt detector 1b closely detects a state of dirt, such as a position of dense dirt and a position of sparse dirt, in the entire detection field-of-view F of the target object detection apparatus 100, that is, in the entire light transmission region of the optical window 12. The controller 1 notifies the vehicle-side ECU 50 of the state of dirt on the optical window 12 thus closely detected. Based on the notification, the vehicle-side ECU 50 appropriately gives a warning that the optical window 12 is dirty, thereby allowing a user to take appropriate measures against the dirt. For example, the user removes the dirt from the optical window 12 or leaves the dirt as it is. Based on the notification, alternatively, the vehicle-side ECU 50 causes the cleaning apparatus to appropriately clean the dirt off the optical window 12 or leaves the dirt as it is to save the cleaning fluid.

According to one or more embodiments of the disclosure, the LDs sequentially emit laser light, and the light scanner 4 scans the predetermined range E with the laser light. The light scanner 4 then deflects the reflected light from the target object Q in the predetermined range E, and any of the PDs receives the reflected light. Therefore, the number of segments X₁ to Xₙ is increased by finely dividing the detection field-of-view F of the target object detection apparatus 100 fronting on the predetermined range E through the optical window 12. The dirt detector 1b thus closely detects a density and an extent of dirt on the optical window 12, based on dirt levels in the respective segments X₁ to Xₙ.

According to one or more embodiments of the disclosure, the dirt detector 1b detects a density and an extent of dirt, based on a sum and an average value of dirt levels, in each of the segment groups Y₁ to Yₘ. Each of the segment groups Y₁ to Yₘ is a subset of segments adjoining one another. The dirt detector 1b therefore detects whether dense dirt Da or sparse dirt Db adheres to portions of the optical window 12, the portions corresponding to the segment groups Y₁ to Yₘ in the detection field-of-view F. In addition, the dirt detector 1b closely determines how much dense or sparse dirt extends over the optical window 12.

According to one or more embodiments of the disclosure, the dirt detector 1b estimates a type of dirt on the optical window 12, based on a result of detection as to dirt in each of the segment groups Y₁ to Yₘ. The controller 1 then notifies the vehicle-side ECU 50 of the result of estimation. The vehicle-side ECU 50 therefore takes more appropriate measures. For example, the vehicle-side ECU 50 changes the details of a warning to be displayed on the display in the vehicle 30, in accordance with the notified type of the dirt on the optical window 12. Alternatively, the vehicle-side ECU 50 changes a cleaning method by the cleaning apparatus, in accordance with the notified type of the dirt on the optical window 12.

According to one or more embodiments of the disclosure, the dirt detector 1b determines urgency of dirt removal, based on a result of detection as to dirt in each of the segment groups Y₁ to Yₘ. The controller 1 then notifies the vehicle-side ECU 50 of the urgency of dirt removal. The vehicle-side ECU 50 therefore outputs an appropriate operating command to the display or cleaning apparatus in the vehicle 30, in accordance with the notified urgency of dirt removal. The vehicle-side ECU 50 thus causes the user or cleaning apparatus to take appropriate measures against the dirt on the optical window 12.

One or more embodiments of the disclosure may be modified as follows. According to one or more embodiments of the disclosure, the controller 1 detects a distance based on a peak of a pulse in light reception signals from the PD module 7, and determines whether the pulse corresponds to a reflected-light signal based on dense dirt Da or sparse dirt Db, in accordance with the distance; however, the disclosure is not limited thereto. In addition to this configuration, for example, the controller 1 may determine whether the pulse corresponds to the reflected-light signal based on the dense dirt Da or sparse dirt Db, in accordance with a peak time of the pulse in the light reception signals, and may detect presence or absence of the dense dirt Da or sparse dirt Db in the corresponding segments X₁ to Xₙ. Alternatively, the controller 1 may determine whether the pulse corresponds to the reflected-light signal based on the target object Q, in accordance with a peak time of the pulse in the light reception signals, and may detect presence or absence of the target object Q in the corresponding segments X₁ to Xₙ.

According to one or more embodiments of the disclosure, the controller 1 calculates a dirt level, based on a peak strength of a reflected-light signal based on dense dirt Da or sparse dirt Db; however, the disclosure is not limited thereto. In addition to this configuration, for example, the controller 1 may calculate a dirt level, based on a pulse width of the reflected-light signal based on the dense dirt Da or sparse dirt Db, or a combination of the pulse width with an amplitude.

According to one or more embodiments of the disclosure, the controller 1, which is a notifier, causes the interface 10, which is a notifier, to notify the vehicle-side ECU 50 of results of detection by the dirt detector 1b, that is, a density of dirt on the optical window 12, an extent of the dirt, a type of the dirt, and urgency of dirt removal; however, the disclosure is not limited thereto. In addition to this configuration, for example, the target object detection apparatus 100 may include a notifier, such as a display, a light emitting diode, or a loud speaker, configured to directly notify a user in a visible or audible manner of at least one of results of detection by the dirt detector 1b, that is, at least one of a density of dirt on the optical window 12, an extent of the dirt, a type of the dirt, or urgency of dirt removal.

According to one or more embodiments of the disclosure, the dirt detector 1b determines urgency of dirt removal at three levels of “high”, “middle”, and “low”; however, the disclosure is not limited thereto. In addition to this configuration, for example, the dirt detector 1b may determine urgency of dirt removal at two levels or at four or more levels, using numerical values.

According to one or more embodiments of the disclosure, the light scanner 4 scans the predetermined range E with the laser light from each LD, and then guides the reflected light from the target object Q in the predetermined range E to each PD; however, the disclosure is not limited thereto. In addition to this configuration, for example, the disclosure is applicable to a target object detection apparatus including a light scanner configured to scan a predetermined range with one of laser light emitted from an LD and the reflected light from a target object Q. The disclosure is also applicable to a target object detection apparatus including no light scanner.

According to one or more embodiments of the disclosure, in the target object detection apparatus 100, the LD module 2 includes eight LDs, and the PD module 7 includes 32 PDs; however, the disclosure is not limited thereto. The number of LDs and the number of PDs may be selected as appropriate. The LDs and PDs may be arranged in any one direction or any two or more directions rather than the vertical direction Z. Alternatively, the target object detection apparatus may include a light emitter including a light emitting element different from that described above, and a light receiver including a light receiving element different from that described above.

According to one or more embodiments of the disclosure, the dirt detector 1b detects a state of dirt on the optical window 12 serving as a light inlet and a light outlet; however, the disclosure is not limited thereto. In addition to this configuration, for example, the target object detection apparatus 100 may include a light-projecting optical window serving as a light outlet and a light-receiving optical window serving as a light inlet, and the dirt detector 1b may detect a state of dirt on one of the optical windows.

According to one or more embodiments of the disclosure, the disclosure is applied to the target object detection apparatus 100 configured to detect the presence or absence of the target object Q and the distance from the target object detection apparatus 100 to the target object Q. Alternatively, the disclosure is also applicable to a target object detection apparatus configured to detect one of presence or absence of a target object and a distance from the target object detection apparatus to the target object.

According to one or more embodiments of the disclosure, the disclosure is applied to the target object detection apparatus 100 to be installed in a vehicle. Alternatively, the disclosure is also applicable to a target object detection apparatus for another use.

While the invention has been described with reference to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A target object detection apparatus comprising:
a light emitter configured to emit measurement light;
a light receiver configured to receive reflected light from a target object in a predetermined range onto which the light emitter projects the measurement light,
the light receiver being configured to output a light reception signal according to a light reception state;
an object detector configured to detect presence or absence of the target object or a distance from the target object detection apparatus to the target object, based on the light reception signal output from the light receiver;
an optical window comprising a light transmissive material that allows transmission of light and serving as a light outlet for the measurement light or a light inlet for the reflected light;
a dirt detector configured to detect presence or absence of dirt on the optical window, based on the light reception signal; and
a notifier configured to provide a notification about the presence of the dirt on the optical window,
wherein the dirt detector detects, based on the light reception signal output from the light receiver, dirt levels in units of segments in a detection field-of-view of the target object detection apparatus fronting on the predetermined range through the optical window, and detects a density and an extent of the dirt, based on the dirt levels, and
wherein the notifier provides a notification about a result of detection by the dirt detector as to the dirt.

2. The target object detection apparatus according to claim 1,
wherein the light emitter comprises a plurality of light emitting elements, and
wherein the light receiver comprises a plurality of light receiving elements,
the target object detection apparatus further comprising:
a light scanner configured to scan the predetermined range with the measurement light emitted from each light emitting element or to guide the reflected light to the light receiver.

3. The target object detection apparatus according to claim 1,
wherein the dirt detector calculates a sum of the dirt levels and an average value of dirt levels in segments where the dirt extends, in each segment group that is a subset of segments adjoining one another, and detects the density and extent of the dirt, based on the sum and the average value.

4. The target object detection apparatus according to claim 3,
wherein the dirt detector detects the density and extent of the dirt on the entire optical window, based on a result of detection in each segment group as to the dirt.

5. The target object detection apparatus according to claim 3,
wherein the dirt detector estimates a type of the dirt, based on a result of detection in each segment group as to the dirt, and
wherein the notifier provides a notification about the type of the dirt estimated by the dirt detector.

6. The target object detection apparatus claim 3,
wherein the dirt detector determines urgency of dirt removal, based on a result of detection in each segment group as to the dirt, and
wherein the notifier provides a notification about the urgency of dirt removal determined by the dirt detector.
